(19) United States
(12) Patent Application Publication
(10) Pub. No.: US 2026/0120354 A1
(43) Pub. Date: Apr. 30, 2026

(54) GENERATING SCALABLE VECTOR GRAPHIC IMAGES BOUND TO INSIGHT-BACKING DATA

(71) Applicant: Adobe Inc., San Jose, CA (US)

(72) Inventors: Yeuk-Yin Chan, New York, NY (US); Tongyu Zhou, Providence, RI (US); Shunan Guo, San Jose, CA (US); Jane Hoffswell, Seattle, WA (US); Chang Xiao, Sunnyvale, CA (US); Victor Soares Bursztyn, Mountain View, CA (US); Eunyee Koh, Sunnyvale, CA (US)

(21) Appl. No.: 18/933,259

(22) Filed: Oct. 31, 2024

(51) Int. Cl. G06T 11/60; G06F 40/40; G06T 7/11; G06T 13/80

(52) U.S. Cl. CPC G06T 11/60; G06F 40/40; G06T 7/11; G06T 13/80; G06T 2200/24; G06T 2207/20132

(57) ABSTRACT

The present disclosure relates to systems, methods, and non-transitory computer-readable media that generate data-bound vector images from input raster images. In some embodiments, the disclosed systems receive, from a client device, a data file and a raster image depicting at least one raster object within a scene. Additionally, the disclosed systems generate at least one scalar vector graphic object from the at least one raster object of the raster image and bind the at least one scalar vector graphic object to data from the data file. Further, the disclosed systems generate a scalar vector graphic image depicting the at least one scalar vector graphic object within the scene based on the data bound to the at least one scalar vector graphic object. The disclosed systems provide the scalar vector graphic image for display on a graphical user interface.

### BACKGROUND

Recent years have seen significant advancement in hardware and software platforms for creating and enhancing digital images. Indeed, as the presence of digital images has become more ubiquitous, platforms have developed to enable the use and creation of these digital images to be more meaningful. For instance, in the field of pictorial visualization, computer-implemented tools or models are often used to create digital images—such as pictorial posters or other infographics—that visually convey insights to viewers. In some cases, these tools or models enable a digital image to convey insights of relevant, external data. To illustrate, some approaches portray a digital image with corresponding data to provide insights regarding the data within the digital image.

### SUMMARY

One or more embodiments described herein provide benefits and/or solve one or more of the foregoing or other problems in the art with systems, methods, and non-transitory computer-readable media that implement a pipeline for deconstructing a raster image into scalar vector graphics (SVG) objects whose attributes are contextualized in data. For instance, in one or more embodiments, the disclosed systems implement a pipeline that involves cropping objects of interest using zero-shot detection, converting the crops into quantized bitmaps, and tracing the results as SVG paths. In some cases, the disclosed systems further generate suggestions for binding the resulting SVG objects and corresponding properties with data fields, enabling modification and animation of the final SVG image based on the mapping. In this manner, the disclosed systems implement a pipeline for flexibly generating a data-bound vectorized output from a raster image while preserving the appearance of the raster image within the SVG result.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an image-to-data integration system operates in accordance with one or more embodiments;

FIG. 2 illustrates an overview diagram of the image-to-data integration system binding data to a raster image in accordance with one or more embodiments;

FIG. 3 illustrates a pipeline implemented by the image-to-data integration system to bind a raster image to data from a data file in accordance with one or more embodiments;

FIG. 4 illustrates the image-to-data integration system generating an SVG object from a raster object in accordance with one or more embodiments;

FIG. 5 illustrates the image-to-data integration system generating label components from a raster image in accordance with one or more embodiments;

FIG. 6 illustrates the image-to-data integration system mapping various data elements from various sources in accordance with one or more embodiments;

FIG. 7 illustrates the image-to-data integration system generating an SVG image in accordance with one or more embodiments;

FIG. 8 illustrates the image-to-data integration system incorporating animation attributes within an SVG image in accordance with one or more embodiments;

FIG. 9 illustrates an example schematic diagram of an image-to-data integration system in accordance with one or more embodiments;

FIG. 10 illustrates a flowchart of a series of acts for generating a data-bound SVG image from an input raster image in accordance with one or more embodiments; and

FIG. 11 illustrates a block diagram of an exemplary computing device in accordance with one or more embodiments.

### DETAILED DESCRIPTION

One or more embodiments described herein include an image-to-data integration system that implements a pipeline for generating a scalar vector graphics (SVG) image having a scene depicted by an existing raster image and having objects bound to insight-backing data.

Despite the advancements in creating and enhancing digital images, several technical problems still exist with respect to creating data-bound digital images providing pictorial visualizations. For instance, conventional pictorial visualization systems suffer from several technological shortcomings that result in inflexible and inaccurate operation.

For example, conventional pictorial visualization systems are inflexible in that they offer a limited solution set for creating data-bound digital images that provide pictorial visualizations (e.g., pictorial posters or other infographics). To illustrate, many conventional systems generate rasterized outputs from raster inputs or vectorized outputs from vector inputs. These systems typically fail, however, to generate data-bound digital images by converting between formats, such as by generating a vectorized output from a raster input.

Conventional systems are also inflexible in that they often fail to bind insight-backing data to digital images providing pictorial visualizations while preserving the original appearance of those images. To illustrate, some conventional systems create data-bound digital images by using input images as backgrounds, glyphs, or stylistic guides for generating a new digital image that provides a new pictorial visualization. Such systems typically generate the new digital image by incorporating the input images within a template visualization (e.g., a bar graph, a line chart, or a scatter plot) that associates the input images with some data. As the template guides the layout of the visual elements (e.g., the input images) in the image output, this approach often causes the layouts of the input images to be lost in favor of the layout of the new visualization.

Further, conventional pictorial visualization systems often fail to operate accurately. For example, as mentioned, conventional systems often generate data-bound digital images with new visualizations from input images. In doing so, these systems provide tools for incorporating insight-backing data into the newly generated output but typically fail to provide tools for incorporating such data within existing images (e.g., the input images). As such, these systems often fail to enable existing images to accurately convey their insights (e.g., enable the images to convey their insights in a way that is consistent with the supporting data).

In one or more embodiments, the image-to-data integration system binds insight-backing data to an existing digital image by generating bindable SVG components for the objects depicted in the digital image. For instance, in certain embodiments, the image-to-data integration system generates an SVG version of an existing raster image, where the SVG version depicts the scene of the existing raster image and includes objects bound to data supporting the insights portrayed therein. The data provides static attributes for the SVG objects in some embodiments and/or animated attributes for the SVG objects in other embodiments.

To illustrate, in one or more embodiments, the image-to-data integration system receives, from a client device, a data file and a raster image depicting at least one raster object within a scene. The image-to-data integration system generates, from the at least one raster object of the raster image, at least one scalar vector graphic object and binds the at least one scalar vector graphic object to data from the data file. Based on the binding, the image-to-data integration system also generates a scalar vector graphic image depicting the at least one scalar vector graphic object within the scene. Further, the image-to-data integration system provides the scalar vector graphic image for display on a graphical user interface.

As indicated above, in one or more embodiments, the image-to-data integration system implements a pipeline for generating an SVG image having objects depicted within a scene portrayed by an existing raster image and bound to data, such as data included in a separate data file. In some cases, the pipeline involves one or more steps for deconstructing an existing raster image to generate a corresponding SVG image and one or more additional steps for binding SVG properties of the SVG image to data that supports the insights portrayed by the scene of the existing raster image (and the resulting SVG image).

In one or more embodiments, the image-to-data integration system deconstructs an existing raster image by extracting one or more raster objects of interest from the raster image. The image-to-data integration system further performs color quantization to generate quantized bitmaps for the extracted raster object(s). From the quantized bitmaps, the image-to-data integration system generates corresponding SVG objects for the SVG image.

In some embodiments, the image-to-data integration system binds properties of the SVG image to data by mapping the SVG objects to the data. In some cases, the image-to-data integration system determines the mapping using embeddings for the SVG objects and embeddings for the data. For example, in some implementations, the image-to-data integration system determines the mapping based on pairwise similarities between the embeddings.

As further indicated, in certain embodiments, the data bound to the SVG image by the image-to-data integration system provide animated attributes for the SVG objects portrayed therein. For instance, in some cases, the data provides one or more in-situ animation attributes that transform an SVG object in place. In some implementations, the data provides one or more motion-path animation attributes that move an SVG object over a particular path. Thus, in some cases, a generates the SVG image to animate the scene depicted by the deconstructed raster image.

The image-to-data integration system provides several advantages over conventional systems. For example, one or more embodiments of the image-to-data integration system improve the flexibility of implementing computing devices when compared to conventional systems. For instance, the image-to-data integration system provides a solution for creating data-bound digital images having pictorial visualizations that is typically unavailable under conventional systems. Indeed, the image-to-data integration system implements a pipeline for data binding that creates a vector output from a raster input. To illustrate, certain embodiments of the image-to-data integration system use an unconventional ordered combination of steps that includes generating SVG objects from a raster image, binding the SVG objects to data from a data file, and generating an SVG image depicting the scene of the raster image based on the binding of data.

Additionally, one or more embodiments of the image-to-data integration system provide improved flexibility by binding insight-backing data to digital images providing pictorial visualizations while preserving the original appearance of those images. In particular, embodiments of the image-to-data integration system generate an output SVG image that depicts the same scene as the input raster image and embeds the scene with the insight-backing data.

Further, one or more embodiments of the image-to-data integration system improve the accuracy of implementing computing devices when compared to conventional systems. In particular, one or more embodiments of the image-to-data integration system enable existing images to more accurately reflect data backing the insights portrayed therein. Indeed, by binding insight-backing data to an existing digital image while preserving its original appearance via generation of a corresponding data-bound SVG object depicting the same scene, the image-to-data integration system produces images that accurately provide insights based on relevant data.

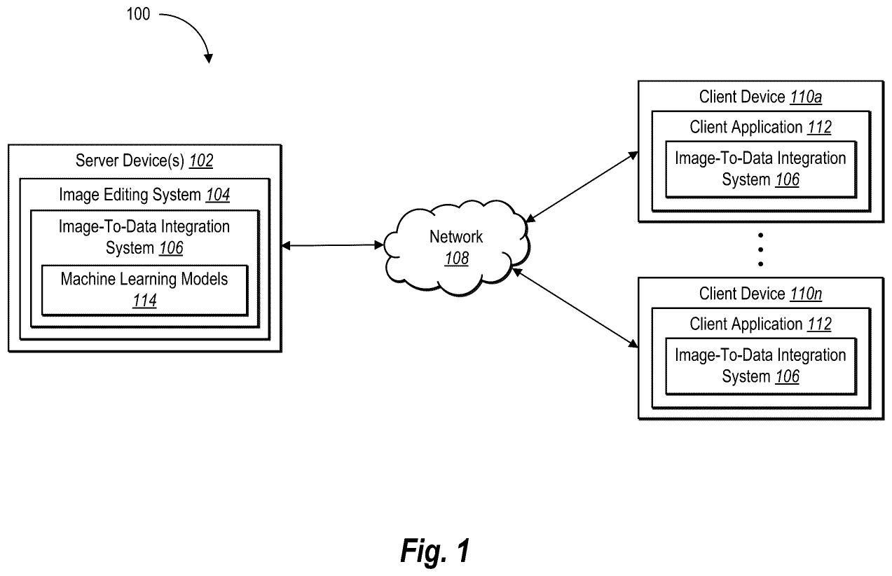

Additional details regarding the image-to-data integration system will now be provided with reference to the figures. For example, FIG. 1 illustrates a schematic diagram of an exemplary system environment (“environment”) 100 in which an image-to-data integration system 106 operates. As illustrated in FIG. 1, the environment 100 includes a server device(s) 102, a network 108, and client devices 110a-110n.

Although the environment 100 of FIG. 1 is depicted as having a particular number of components, the environment 100 is capable of having any number of additional or alternative components (e.g., any number of server devices, client devices, or other components in communication with the image-to-data integration system 106 via the network 108). Similarly, although FIG. 1 illustrates a particular arrangement of the server device(s) 102, the network 108, and the client devices 110a-110n, various additional arrangements are possible.

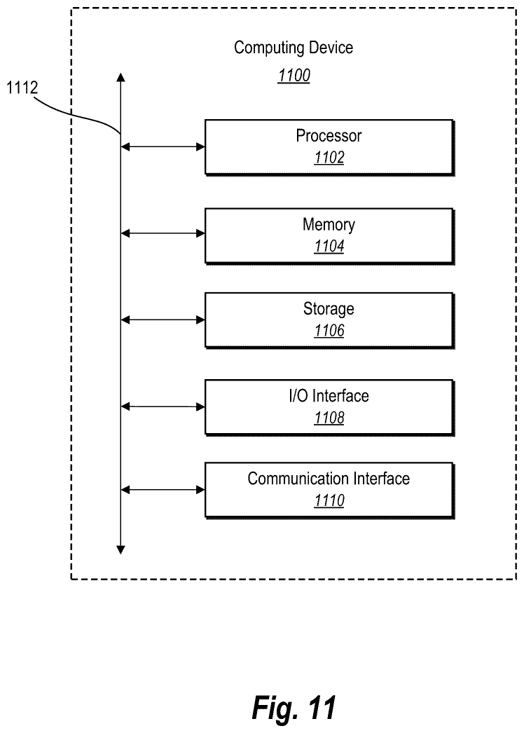

The server device(s) 102, the network 108, and the client devices 110a-110n are communicatively coupled with each other either directly or indirectly (e.g., through the network 108 discussed in greater detail below in relation to FIG. 11). Moreover, the server device(s) 102 and the client devices 110a-110n include one of a variety of computing devices (including one or more computing devices as discussed in greater detail with relation to FIG. 11).

As mentioned above, the environment 100 includes the server device(s) 102. In one or more embodiments, the server device(s) 102 generates, stores, receives, and/or transmits data including data files and digital images (e.g., rater images and/or SVG images). In one or more embodiments, the server device(s) 102 comprises a data server. In some implementations, the server device(s) 102 comprises a communication server or a web-hosting server.

In one or more embodiments, the image editing system 104 provides functionality by which a client device (e.g., a user of one of the client devices 110a-110n) generates, edits, manages, and/or stores digital images. For example, in some instances, a client device sends a digital image to the image editing system 104 hosted on the server device(s) 102 via the network 108. The image editing system 104 then provides many options that are usable by the client device to edit the digital image, store the digital image, and subsequently search for, access, and view the digital image. For instance, in some cases, the image editing system 104 provides one or more options that are usable by the client device to bind a raster image to data from a separate data file by creating an SVG image from the raster image and map the objects portrayed within the SVG image to data from the data file.

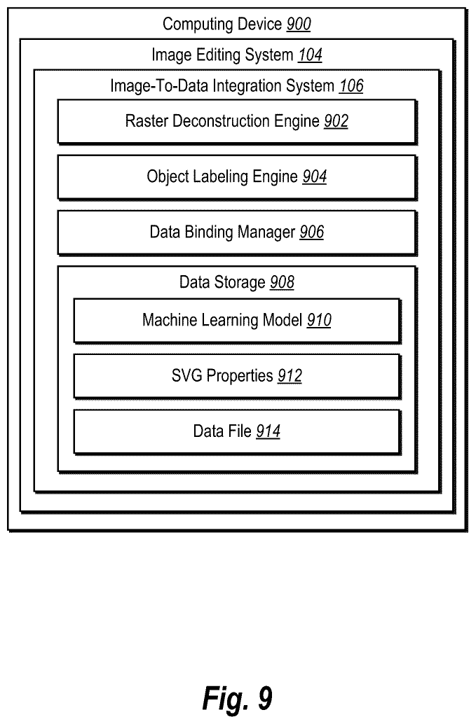

Additionally, the server device(s) 102 include the image-to-data integration system 106. In one or more embodiments, via the server device(s) 102, the image-to-data integration system 106 binds a raster image to data from a separate data file. For instance, in some cases, the image-to-data integration system 106, via the server device(s) 102, deconstructs the raster image to generate SVG objects that correspond to raster objects portrayed in the raster image. Via the server device(s) 102, the image-to-data integration system 106 further generates embeddings for labels and descriptions of the raster objects, column and row names for the data in the data file, and SVG property names. Using the embeddings, the image-to-data integration system 106, via the server device(s) 102, maps the data to the SVG objects. Example components of the image-to-data integration system 106 will be described below with regard to FIG. 9.

In one or more embodiments, the client devices 110a-110n include computing devices that that are capable of accessing, modifying, and/or storing digital files, including digital images and data files. For example, in some embodiments, the client devices 110a-110n include smartphones, tablets, desktop computers, laptop computers, head-mounted-display devices, or other electronic devices. In some instances, the client devices 110a-110n include one or more applications (e.g., the client application 112) that are capable of accessing, modifying, and/or storing digital files, including digital images and data files. For example, in some embodiments, the client application 112 includes a software application installed on the client devices 110a-110n. In other cases, however, the client application 112 includes a web browser or other application that accesses a software application hosted on the server device(s) 102.

One or more embodiments of the image-to-data integration system 106 are implemented in whole, or in part, by the individual elements of the environment 100. Indeed, as shown in FIG. 1, one or more embodiments of the image-to-data integration system 106 are implemented with regard to the server device(s) 102 and/or at the client devices 110a-110n. In particular embodiments, the image-to-data integration system 106 on the client devices 110a-110n comprises a web application, a native application installed on the client devices 110a-110n (e.g., a mobile application, a desktop application, a plug-in application, etc.), or a cloud-based application where part of the functionality is performed by the server device(s) 102.

In additional or alternative embodiments, the image-to-data integration system 106 on the client devices 110a-110n represents and/or provides the same or similar functionality as described herein in connection with the image-to-data integration system 106 on the server device(s) 102. In some implementations, the image-to-data integration system 106 on the server device(s) 102 supports the image-to-data integration system 106 on the client devices 110a-110n.

For example, in some embodiments, the image-to-data integration system 106 on the server device(s) 102 trains one or more machine learning models described herein (e.g., the one or more machine learning model(s) 114). The image-to-data integration system 106 on the server device(s) 102 provides the one or more trained machine learning models to the image-to-data integration system 106 on the client devices 110a-110n for implementation. Accordingly, although not illustrated, in one or more embodiments, the image-to-data integration system 106 on the client devices 110a-110n uses the one or more trained machine learning models to bind raster images to data from a separate data file independent from the server device(s) 102.

In some embodiments, the image-to-data integration system 106 includes a web hosting application that allows the client devices 110a-110n to interact with content and services hosted on the server device(s) 102. To illustrate, in one or more implementations, the client devices 110a-110n accesses a web page or computing application supported by the server device(s) 102. The client devices 110a-110n provide input to the server device(s) 102, such as a digital image and a data file containing data to be bound to the digital image. In response, the image-to-data integration system 106 on the server device(s) 102 binds the data to the digital image. The server device(s) 102 then provides the data-bound digital file to the client devices 110a-110n.

In some embodiments, though not illustrated in FIG. 1, the environment 100 has a different arrangement of components and/or has a different number or set of components altogether. For example, in certain embodiments, the client devices 110a-110n communicate directly with the server device(s) 102 bypassing the network 108. As another example, the environment 100 includes a third-party server device comprising a content server and/or a data collection server.

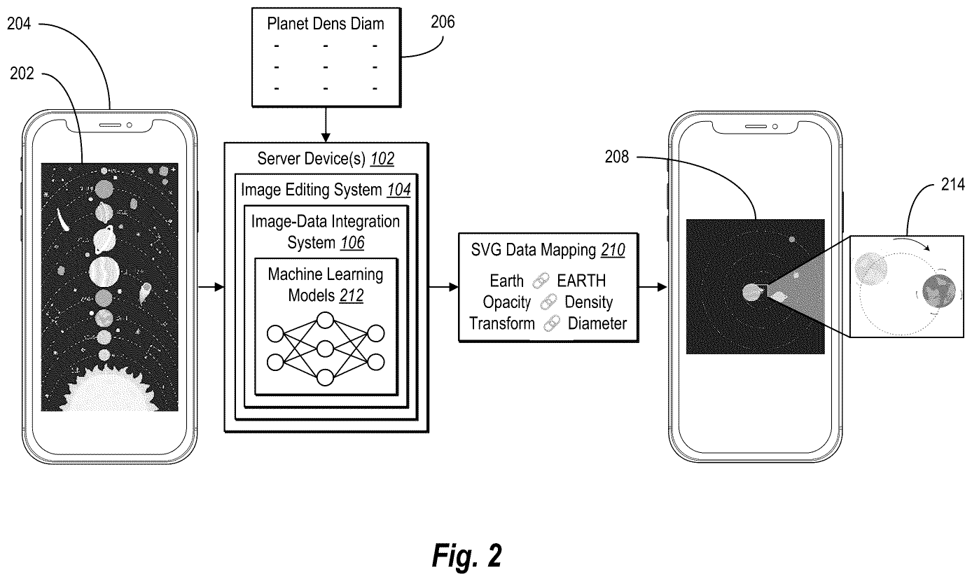

As mentioned, in one or more embodiments, the image-to-data integration system 106 binds a raster image to data from a separate data file. In particular, the image-to-data integration system 106 generates a scalar vector graphics (SVG) image from the raster image and binds the objects of the SVG image to the data. FIG. 2 illustrates an overview diagram of the image-to-data integration system 106 binding data to a raster image in accordance with one or more embodiments.

As shown in FIG. 2, the image-to-data integration system 106 receives a raster image 202 from a client device 204. In one or more embodiments, a raster image includes a raster digital image. In particular, in some embodiments, a raster image includes a digital image that is made up of individual pixels. For instance, in some cases, a raster image includes a grid of pixels where each pixel includes image information for the location of the pixel. To illustrate, in some cases, each pixel includes color information. In some cases, a raster image includes an image file (i.e., a raster image file, such as JPEG or GIF). In some implementations, a raster image includes a pixel-based visual portrayal of a scene that is part of its own file or part of another file (e.g., part of a non-image file). Indeed, as shown in FIG. 2, the raster image 202 depicts a plurality of raster objects within a scene. Though a particular number of raster objects are shown, the image-to-data integration system 106 operates on raster images depicting various numbers of raster objects in various implementations.

In one or more embodiments, a raster object includes an object portrayed in a raster image. In particular, in some embodiments, a raster object includes an object in which the shape, colors, dimensions, boundaries, and/or other visible attributes of the object are defined by information contained in a set of pixels. In some instances, a raster object more generally includes a portion (e.g., a distinct portion) of a raster image, such as the foreground, the background, the sky, the ground, or the landscape, or a portion thereof.

In one or more embodiments, a scene includes a visual characterization of a digital image, such as a raster image or a SVG image. In particular, in some embodiments, a scene includes an appearance of a digital image. To illustrate, in certain cases, a scene includes a set of visual elements depicted within a digital image. In some cases, a scene includes the layout of the visual elements within the digital image. In certain embodiments, however, a scene more generally refers to which visual elements are depicted within the digital image regardless of their arrangement.

FIG. 2 provides a particular example in which the raster image 202 provides a pictorial visualization of a scene including the solar system. In particular, the raster image 202 depicts the sun and planets of the solar system. The pictorial visualization of the raster image 202 provides various insights, such as the objects included in the solar system, the ordering of the planets, and their relative sizes. As shown, however, some of the insights provided by the pictorial visualization do not strictly adhere to relevant data. For instance, while the raster image 202 depicts the relative sizes of the planets, it does not depict their actual sizes to scale. Further, the raster image 202 depicts the ordering of the planets but fails to depict their orbits or distances from the sun to scale.

As further shown in FIG. 2, the image-to-data integration system 106 also receives a data file 206. For instance, in some cases, the image-to-data integration system 106 receives the data file 206 from the client device 204. In one or more embodiments, a data file includes a file containing digital data. In particular, in some embodiments, a data file includes a file containing textual or numerical data. In some cases, a data file is separate from another file but includes data that is relevant to the other file. For example, in some instances, a data file is separate from an image file (e.g., a raster image file) but includes data that is relevant to the image file. For instance, in certain cases, a data file includes data related to a scene portrayed in the image file, such as data related to one or more objects portrayed within the scene. To illustrate, in some cases, a data file includes a label for an object and/or a description of one or more attributes of the object, such as size, color, density, diameter, distance relative to another object, or movement pattern. In some cases, at least some of the data in the data file includes data that is depictable in a visual medium.

Indeed, as shown by FIG. 2, the data file 206 is separate from the raster image 202 but includes data that is relevant to the raster image 202. For example, in some cases, the data file 206 includes a dataset that was created separately from the raster image 202, but the data included in the data file 206 corresponds to the one or more objects depicted in the raster image 202 (e.g., factual data collected about the object(s) or user-created data for the object(s)).

Specifically, to further the example above, in certain cases, the data file 206 of FIG. 2 includes data corresponding to the planets of the solar system that are depicted in the raster image 202. For example, in some embodiments, the data file 206 includes data providing various attributes of the planets, such as their sizes, densities, and/or distances from the sun. Thus, while the data file 206 is a separate file, it includes data of interest with respect to the raster image 202.

In some cases, the data file 206 includes a particular format such that the included data is organized based on or otherwise adheres to the format. For instance, in some embodiments, the data within the data file 206 includes rows and columns of data. In some instances, the data further includes headers for the rows and/or the columns, where a header provides a name or other indication for a row or a column regarding the data record or particular data values to be included in the data fields of that row or column. To illustrate, in one or more embodiments, the data file 206 includes a text file, such as a comma-separated values (CSV) file, an initialization file, or a semicolon-separated values (SCSV) file.

In one or more embodiments, the image-to-data integration system 106 receives the raster image 202 and/or the data file 206 from an external device. Indeed, as indicated by FIG. 2, the image-to-data integration system 106 operates on the server device(s) 102 and receives the raster image 202 and the data file 206 from the client device 204. In some instances, however, the image-to-data integration system 106 receives at least one of the raster image 202 or the data file 206 by retrieving the file from local storage or receiving the file from another system operating on the same device. For example, in some cases, the client device 204 accesses raster images stored on the server device(s) 102 through an application of the client device 204. Thus, the image-to-data integration system 106 retrieves a raster image from storage upon its selection. In some cases, the image-to-data integration system 106 receives (e.g., retrieves) at least one of the raster image 202 or the data file 206 from a third-party device. In some instances, the image-to-data integration system 106 retrieves the raster image 202 and/or the data file 206 from remote storage.

As shown in FIG. 2, the image-to-data integration system 106 generates an SVG image 208 from the raster image 202. In one or more embodiments, a scalar vector graphics (SVG) image includes an SVG digital image. In particular, in some embodiments, an SVG image includes a digital image that is made up of vector graphics. For instance, in some cases, an SVG image includes one or more points, lines, shapes, or curves defined by vector graphics (e.g., mathematical equations supporting the vector graphics). In some cases, an SVG image includes an image file (i.e., a SVG image file). In some implementations, a SVG image includes a vector-based visual portrayal of a scene that is part of its own file or part of another file (e.g., part of a non-image file). Indeed, as shown in FIG. 2, the SVG image 208 depicts a plurality of SVG objects within a scene.

In one or more embodiments, an SVG object includes an object portrayed in an SVG image. In particular, in some embodiments, an SVG object includes an object in which the shape, colors, dimensions, boundaries, and/or other visible attributes of the object are defined by vector graphics. In some instances, an SVG object more generally includes a portion (e.g., a distinct portion) of an SVG image, such as the foreground, the background, the sky, the ground, or the landscape, or a portion thereof.

As shown in FIG. 2, the scene depicted in the SVG image 208 corresponds to the scene depicted in the raster image 202. Further, the SVG objects depicted within the scene of the SVG image 208 corresponds to the raster objects depicted in the scene of the raster image 202. Thus, in one or more embodiments, the image-to-data integration system 106 preserves the scene of the raster image 202 (including the objects depicted therein) when generating the SVG image 208. For instance, as will be discussed in more detail below, in certain embodiments, the image-to-data integration system 106 deconstructs the raster image 202 to generate corresponding SVG objects and creates the SVG image 208 to depict the same scene.

As further shown in FIG. 2, the image-to-data integration system 106 generates an SVG data mapping 210 in generating the SVG image 208. In particular, the image-to-data integration system 106 generates the SVG data mapping 210 to bind the SVG image 208 to data from the data file 206. For instance, in some cases, the image-to-data integration system 106 binds the SVG objects of the SVG image 208 to the data. In some embodiments, the image-to-data integration system 106 binds the data to the SVG image 208 by incorporating the data within the SVG image 208 (e.g., embedding or otherwise incorporating the data within the SVG image file) in accordance with the SVG data mapping 210.

By binding the data to the SVG image 208 in accordance with the SVG data mapping 210, the image-to-data integration system 106 generates the SVG image 208 to provide a pictorial visualization having data-backed insights. Indeed, to speak further to the particular example depicted in FIG. 2, the SVG image 208 depicts the sizes of the planets to scale and further depicts their distances from the sun to scale based on the data of the data file 206. Thus, while the SVG image 208 depicts the same scene as the raster image 202 (e.g., the solar system), the insights of the SVG image 208 are supported by the data from the data file 206.

Additionally, as shown in FIG. 2, the image-to-data integration system 106 uses one or more machine learning models 212 in creating the SVG data mapping 210 and/or the SVG image 208. In one or more embodiments, a machine learning model includes a computer-implemented model that is tunable (e.g., trainable) based on inputs to approximate unknown functions. In particular, in some embodiments, a machine learning model includes a model that uses algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), association rule learning, inductive logic programming, support vector learning, Bayesian network, regression-based model (e.g., censored regression), principal component analysis, or a combination thereof.

As illustrated by the box 214 of FIG. 2, the SVG image 208 includes an animated SVG image. In one or more embodiments, an animated SVG image includes an SVG image having one or more portions that are animated. For instance, in some embodiments, an animated SVG image includes an SVG image depicting an animation of one or more of SVG objects portrayed therein. Thus, the image-to-data integration system 106 generates the SVG image 208 as an animated SVG image in some instances or a static (i.e., non-animated) SVG image in other cases. In some embodiments, the image-to-data integration system 106 generates the SVG image 208 as a static image or an animated image based on the data included in the data file 206. Generating animated SVG images will be discussed more below.

FIG. 2 portrays the raster image 202 and the SVG image 208 as a particular type of digital image—such as a pictorial poster or other infographic—providing a pictorial visualization. It should be noted, however, that various implementations of the image-to-data integration system 106 work with various types of digital images and are not confined to infographics.

By generating an SVG image from a raster image, one or more embodiments of the image-to-data integration system 106 provide improved flexibility when compared to conventional systems. Indeed, embodiments of the image-to-data integration system 106 provide a pipeline for generating a data-bound vector from a raster input, which is typically unavailable under conventional systems. As will be discussed below, certain embodiments of the image-to-data integration system 106 employ an unconventional ordered combination of steps in implementing such a pipeline.

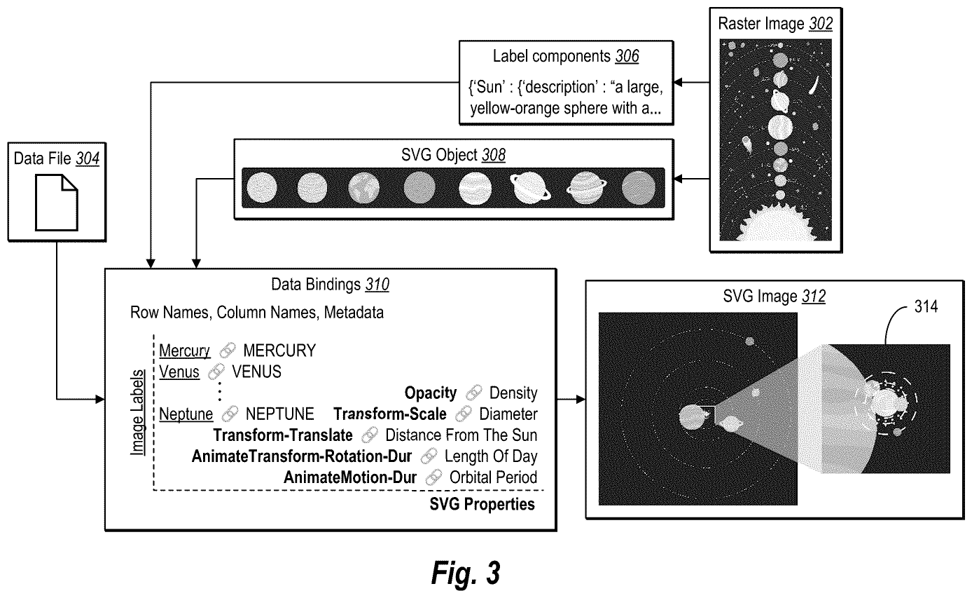

As discussed, in one or more embodiments, the image-to-data integration system 106 implements a pipeline to bind a raster image to data from a data file. For example, in some embodiments, the image-to-data integration system 106 implements a pipeline for using a raster image to generate a corresponding SVG image and binding the SVG image to the data from a data file. FIG. 3 illustrates a pipeline implemented by the image-to-data integration system 106 to bind a raster image to data from a data file in accordance with one or more embodiments.

As shown in FIG. 3, the image-to-data integration system 106 receives, retrieves, or otherwise obtains a raster image 302. Further, the image-to-data integration system 106 receives, retrieves, or otherwise obtains a data file 304.

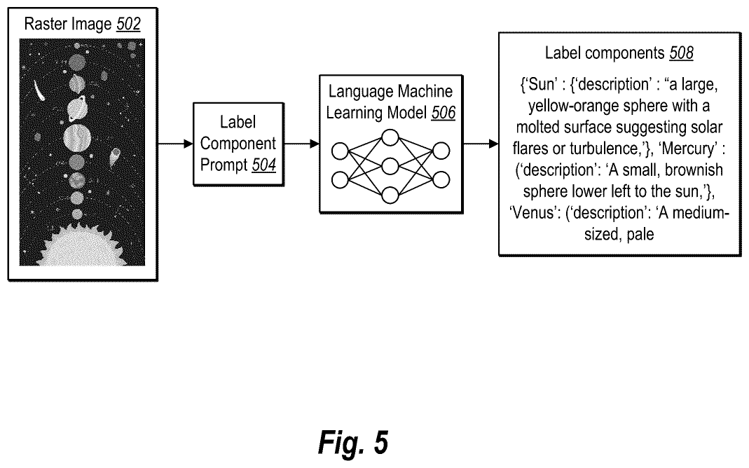

As illustrated, the image-to-data integration system 106 generates label components 306 from the raster image 302. In some cases, the image-to-data integration system 106 generates the label components 306 by generating a label and a textual description for each raster object identified within the raster image 302. In some instances, the image-to-data integration system 106 uses a language machine learning model to generate the label components 306 as will be discussed in more detail below with reference to FIG. 5.

In one or more embodiments, a label for a raster object includes a classification label indicating the object type of the raster object. In some cases, however, a label for a raster object includes an identifying label for a raster object providing an identification of the raster object. In other words, the label provides an identifier (e.g., a unique identifier) for the raster object. For example, in some instances, a label provides a particular name associated with the object. The length of the label generated by the image-to-data integration system 106 varies in various implementations. Further, in some embodiments, a label includes a text-based label, such as a label that includes, but is not limited to, alphanumeric characters.

In one or more embodiments, a textual description of a raster object includes a text-based description of the raster object. In particular, in some embodiments, a textual description of a raster object includes text providing a high-level description or summary of the raster object. To illustrate, in certain embodiments, a textual description of a raster object includes text providing information on the raster object, such as by providing a description of one or more characteristics (e.g., visual characteristics, physical characteristics, and/or behavioral characteristics) of the raster object. In some cases, a textual description includes a one-sentence description of the object, though descriptions of various lengths are used in various embodiments.

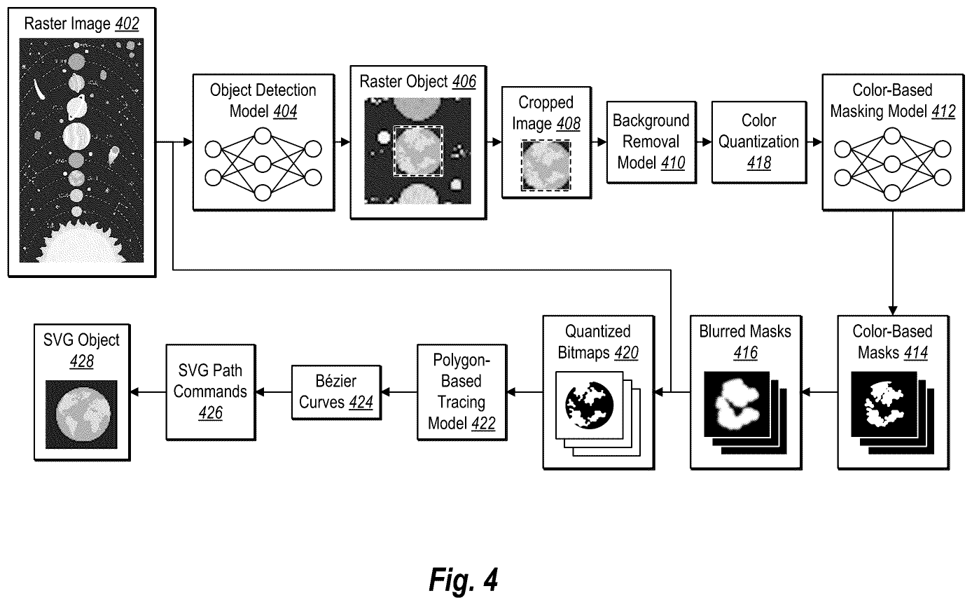

Additionally, as illustrated, the image-to-data integration system 106 generates SVG objects 308 from the raster image 302. For instance, in one or more embodiments, the image-to-data integration system 106 generates an SVG object for each raster object depicted within the raster image 302. In some embodiments, the image-to-data integration system 106 generates the SVG objects 308 by deconstructing the raster image 302. For instance, in some cases, the image-to-data integration system 106 detects the raster objects portrayed in the raster image 302, generates one or more quantized bitmaps for each detected raster object, and constructs the SVG objects 308 by tracing the quantized bitmaps. Generating SVG objects from a raster image will be discussed in more detail below with reference to FIG. 4.

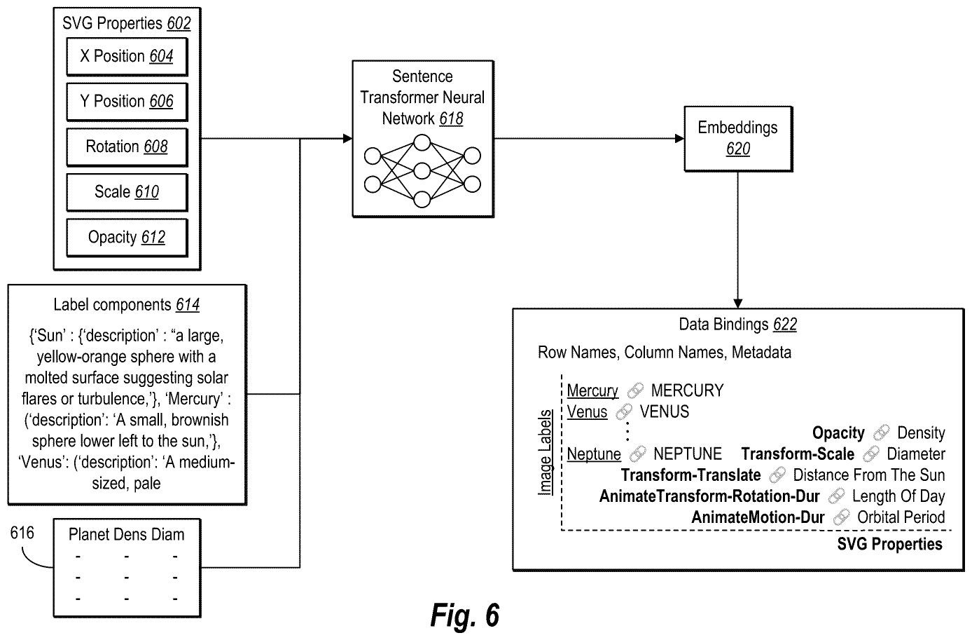

As further illustrated, the image-to-data integration system 106 determines data bindings 310 using the data file 304, the label components 306, and/or the SVG objects 308. For instance, in certain embodiments, the image-to-data integration system 106 determines pairs of bindings, where each pair includes two of a label from the label components 306, a textual description from the label components 306, a row name from the data file 304, a column name from the data file 304, or an SVG property associated with the SVG objects 308. In one or more embodiments, the image-to-data integration system 106 determines the data bindings 310 by generating embeddings and determining pairwise similarity metrics among the embeddings as will be discussed in more detail below with reference to FIG. 6.

As shown by FIG. 3, the image-to-data integration system 106 generates an SVG image 312 using the data bindings 310 and/or the SVG objects 308. In particular, in some cases, the image-to-data integration system 106 generates the SVG image 312 to depict the SVG objects 308 based on the data bound to the SVG objects 308 via the data bindings 310. As indicated by the box 314, the SVG image 312 includes an animated SVG image. For instance, the SVG image 312 depicts an animation of one or more of the SVG objects 308 based on the data bound to those objects.

As mentioned, in one or more embodiments, the image-to-data integration system 106 generates SVG objects from raster objects depicted within a raster image. FIG. 4 illustrates the image-to-data integration system 106 generating an SVG object from a raster object in accordance with one or more embodiments.

As shown in FIG. 4, the image-to-data integration system 106 uses an object detection model 404 to detect a raster object 406 depicted within a raster image 402. In one or more embodiments, an object detection model includes a computer-implemented model that detects objects portrayed within digital images, such as raster images or SVG images. In some embodiments, an object detection model includes a computer-implemented machine learning model trained to detect objects portrayed within images. For instance, in some cases, an object detection model includes a neural network (e.g., a deep neural network) having learned parameters for detecting objects within a digital image. In certain cases, an object detection model generates a bounding box for a detected object. Thus, upon detecting multiple objects, an object detection model outputs a plurality of bounding boxes in some cases—one bounding box per detected object.

In one or more embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

As illustrated in FIG. 4, the image-to-data integration system 106 generates a cropped image 408 for the raster object 406 detected from the raster image 402. In one or more embodiments, a cropped image includes a digital image derived from another digital image, where the cropped image includes a cropped portion of the other digital image. In particular, in some embodiments, a cropped image includes a cropped portion of a digital image, where the cropped portion depicts an object from the digital image. To illustrate, in some cases, the image-to-data integration system 106 generates the cropped image 408 from the raster image 402 by cropping the raster object 406 around the bounding box generated by the object detection model 404.

As further illustrated in FIG. 4, the image-to-data integration system 106 provides the cropped image 408 to a background removal model 410. In one or more embodiments, a background removal model includes a computer-implemented model for removing the background of a digital image. In particular, in some embodiments, a background removal model includes a computer-implemented model for removing the background around an object portrayed in a digital image. Thus, in some cases, a background removal model receives a digital image (e.g., a cropped image) depicting an object against a background as input and produces a digital image depicting the object without the background or a blank (e.g., white) background as output. In certain embodiments, a background removal model includes a computer-implemented machine learning model, such as a neural network.

In one or more embodiments, the background removal model 410 includes a neural network having a deep convolutional neural network (e.g., a fully convolutional neural network) architecture that performs image segmentation. For instance, in some cases, the background removal model 410 includes an encoder-decoder architecture where the encoder extracts features (e.g., multi-scale features) from the input image (e.g., the cropped image 408), and the decoder reconstructs a mask that distinguishes the foreground from the background. In such embodiments, the background removal model 410 applies the generated mask to the input image to remove the background while keeping the object depicted therein intact.

As indicated by FIG. 4, the image-to-data integration system 106 further performs color quantization 418 on the cropped image 408 of the raster object 406 with the background removed. In particular, the image-to-data integration system 106 performs the color quantization 418 by splitting the raster object 406 into n colors. In one or more embodiments, the image-to-data integration system 106 establishes the value for n (e.g., as a default value). In some cases, the image-to-data integration system 106 receives user input from a client device with respect to n and sets the value of n in accordance with the user input.

Additionally, as shown in FIG. 4, the image-to-data integration system 106 uses a color-based masking model 412 to generate a set of color-based masks 414 from the cropped image 408 with the background removed after the color quantization 418. In particular, in some embodiments, the image-to-data integration system 106 generates n color-based masks—one color-based mask for each color resulting from the color quantization 418. In some cases, such as where n is larger than the number of colors depicted by the raster object 406, the image-to-data integration system 106 generates a color-based mask for each color depicted therein.

In one or more embodiments, a color-based mask includes a mask for a color depicted in a digital image (e.g., a cropped image). In particular, in some embodiments, a color-based mask includes a mask for a color of an object (e.g., a raster object) depicted in a digital image. In other words, in some cases, a color-based mask includes a mask of one or more portions of a digital image (e.g., a digital object in the digital image) that portray a particular color. For instance, in certain embodiments, a color-based mask includes a binary mask with a first set of pixels having a first value (e.g., a value of one) indicating that those pixels depict a particular color and a second set of pixels having a second value (e.g., a value of zero) indicating that those pixels do not depict that color (e.g., the pixels depict some other color).

In one or more embodiments, a color-based masking model includes a computer-implemented model for generating one or more color-based masks from a digital image. In particular, in some embodiments, a color-based masking model includes a model that analyzes an input image (e.g., a cropped image of a raster object having the background removed) and generates one or more color-based masks for the input image (e.g., for the raster object) based on the analysis. In some embodiments, a color-based masking model includes a computer-implemented machine learning model, such as a neural network. For instance, in some cases, a color-based masking model includes a neural network having a convolution-based architecture trained to generate a color-based mask for each color depicted in an input image.

As shown in FIG. 4, the image-to-data integration system 106 generates a set of blurred masks 416 from the set of color-based masks 414. For instance, in some embodiments, the image-to-data integration system 106 generates a blurred mask for each color-based mask in the set of color-based masks 414. To illustrate, in some cases, the image-to-data integration system 106 applies a Gaussian blur to each color-based mask. In some instances, the image-to-data integration system 106 uses the Gaussian blur for anti-aliasing and thus smoother subsequent paths later. In certain embodiments, the image-to-data integration system 106 establishes a value for the standard deviation of the Gaussian blur. In some cases, the image-to-data integration system 106 receives user input from a client device with respect to the standard deviation and sets the value of the standard deviation based on the user input.

As further shown in FIG. 4, the image-to-data integration system 106 uses the set of blurred masks 416 to generate a set of quantized bitmaps 420. In particular, the image-to-data integration system 106 uses the set of blurred masks 416 to extract the set of quantized bitmaps 420 from the raster image 402. For instance, in some embodiments, the image-to-data integration system 106 uses a blurred mask from the set of blurred masks 416 to extract a quantized bitmap from the raster image 402 (e.g., from the raster object 406 depicted in the raster image 402). Thus, in some cases, the image-to-data integration system 106 uses a blurred mask for a particular color (e.g., a quantized color) depicted in the raster image 402 (e.g., depicted by the raster object 406 of the raster image 402) to extract a quantized bitmap for that color. Further, in certain instances, the image-to-data integration system 106 generates a quantized bitmap for each blurred mask.

In one or more embodiments, a quantized bitmap includes a digital image that is derived from another digital image and depicts a subset of the colors depicted by the other digital image. In particular, in some embodiments, a quantized bitmap includes a digital image that is derived from a source image depicting a set of colors and that portrays one or more portions of the source image that depict a subset of those colors. For instance, in some cases, a quantized bitmap portrays a portion of the source image that depicts one color. In certain embodiments, a quantized bitmap corresponds to a particular object depicted in the source image and portrays a subset of the colors (e.g., one color) depicted by that object. Thus, in some implementations, the image-to-data integration system 106 generates the set of quantized bitmaps 420 for the raster object 406 by generating a quantized bitmap for each color (e.g., each of the n colors resulting from the color quantization 418) depicted by the raster object 406.

Additionally, as illustrated in FIG. 4, the image-to-data integration system 106 uses a polygon-based tracing model 422 to generate Bezier curves 424 from the set of quantized bitmaps 420. For instance, in some cases, the image-to-data integration system 106 uses the polygon-based tracing model 422 to generate one or more Bezier curves from each quantized bitmap.

In one or more embodiments, a polygon-based tracing model includes a computer-implemented model or algorithm that creates one or more vector representations of a digital image, such as a quantized bitmap. In some embodiments, a polygon-based tracing model includes a computer-implemented model that generates one or more polygons from a digital image. In some cases, however, a polygon-based training algorithm generates one or more Bezier curves from a digital image. In some embodiments, a polygon-based tracing model generates one or more polygons as an intermediate representation of the digital image and generates the one or more Bezier curves from the polygon(s). In some implementations, a polygon-based tracing model generates the one or more polygons and/or Bezier curves as approximations of the raster image. In certain embodiments, a polygon-based tracing model includes one or more machine learning models, such as one or more neural networks.

To illustrate, in one or more embodiments, the image-to-data integration system 106 uses the polygon-based tracing model 422 to execute steps that include: (i) decomposing a quantized bitmap into a set of paths; (ii) approximating each path using an optimal polygon; and (iii) transforming each polygon into a Bezier curve. In some embodiments, the image-to-data integration system 106 further uses the polygon-based tracing model 422 combine adjacent Bezier curves into a larger path.

As shown in FIG. 4, the image-to-data integration system 106 generates SVG path commands 426 from the Bezier curves 424. In particular, in some cases, the image-to-data integration system 106 generates one or more SVG path commands from each Bezier curve. In some embodiments, the image-to-data integration system 106 generates an SVG path command from a Bezier curve by using the end points of the Bezier curve as end points of the SVG path. In various embodiments, the image-to-data integration system 106 employs various tools/libraries for generating the SVG path commands 426 from the Bezier curves.

In certain embodiments, the image-to-data integration system 106 combines the SVG path commands 426 to form a structured SVG path. For instance, in some cases, the image-to-data integration system 106 concatenates the SVG path commands 426 to form a structured SVG path. More particularly, in some cases, the image-to-data integration system 106 combines (e.g., concatenates) the SVG path commands generated from the Bezier curves created for a quantized bitmap to form a structured SVG path for the quantized bitmap. Thus, in some cases, the image-to-data integration system 106 generates one or more structured SVG paths for each quantized bitmap. In some instances, however, the image-to-data integration system 106 forms one structured SVG path for the raster object 406 by combining (e.g., concatenating) all SVG path commands 426 generated from the Bezier curves 424.

As indicated in FIG. 4, the image-to-data integration system 106 uses the SVG path commands 426 (e.g., the one or more structured SVG paths created from the SVG path commands 426) to generate an SVG object 428 for the raster object 406. In particular, in some cases, the image-to-data integration system 106 uses the traced paths resulting from the SVG path commands 426 to generate the SVG object 428. In some instances, the image-to-data integration system 106 concatenates the traced paths to form the SVG object 428.

While FIG. 4 illustrates the image-to-data integration system 106 generating a single SVG object (i.e., the SVG object 428) from a single raster object (i.e., the raster object 406) detecting within a raster image 402, the image-to-data integration system 106 generates multiple SVG objects in some implementations. Indeed, in some cases, the image-to-data integration system 106 generates an SVG object for one or more raster object detected within a raster image. In particular, in some instances, the image-to-data integration system 106 generates cropped image for the raster object, generates a set of quantized bitmaps from the cropped image, and generates SVG paths that are used to create an SVG object as described above.

In one or more embodiments, in addition to generating SVG objects from the raster objects depicted in a raster image, the image-to-data integration system 106 generates label components from a raster image. FIG. 5 illustrates the image-to-data integration system 106 generating label components from a raster image in accordance with one or more embodiments.

As shown in FIG. 5, the image-to-data integration system 106 uses a raster image 502 to generate a label component prompt 504. In particular, the image-to-data integration system 106 generates the label component prompt 504 for a language machine learning model 506.

In one or more embodiments, a language machine learning model includes a computer-implemented machine learning model trained to comprehend and generate human language text. In particular, in some embodiments, a language machine learning model includes a neural network (e.g., a deep neural network) with many parameters trained on large quantities of data (e.g., unlabeled text) using a particular learning technique (e.g., self-supervised learning). For example, in some cases, a language machine learning model includes parameters trained to generate natural language text output from natural language text input or other input (e.g., a digital image, such as a raster image). In certain implementations, a language machine learning model includes a large language model. Some examples of large language models include, but are not limited to, chat generative pre-trained transformer (Chat GPT), Gemini, and Large Language Model Meta AI (LLaMA).

In one or more embodiments, the image-to-data integration system 106 generates the label component prompt 504 to include the raster image 502. In some cases, the image-to-data integration system 106 further generates the label component prompt 504 to include instructions to the language machine learning model 506. For instance, in some cases, the image-to-data integration system 106 includes examples of object details (e.g., size, color, or density) to be included as part of the output of the language machine learning model 506. In some embodiments, the image-to-data integration system 106 includes guardrails, such as instructions that prevent the language machine learning model 506 from providing unwanted output (e.g., instructions that prevent the output from describing steps for the user to take in determining the requested information) or instructions that otherwise guide the language machine learning model 506 in the generation of the output (e.g., instructions that require the output to include labels and/or textual descriptions of the raster objects in the raster image 502).

As shown in FIG. 5, the image-to-data integration system 106 provides the label component prompt 504 to the language machine learning model 506 and uses the language machine learning model 506 to generate label components 508 accordingly. For example, in some cases, the image-to-data integration system 106 uses the language machine learning model 506 to generate a label and a textual description for each raster object depicted in the raster image 502.

As previously discussed, in one or more embodiments, the image-to-data integration system 106 binds data from a data file to a raster image. In particular, the image-to-data integration system 106 binds the data from the data file to SVG objects generated from the raster image. In some cases, the image-to-data integration system 106 binds the data from the data file by generating a mapping that associates various data elements from various sources together. FIG. 6 illustrates the image-to-data integration system 106 mapping various data elements from various sources in accordance with one or more embodiments.

As shown in FIG. 6, the image-to-data integration system 106 determines SVG properties 602. In one or more embodiments, an SVG property includes an attribute of an SVG element that is rendered visually. For instance, in some embodiments, an SVG property includes an attribute of an SVG object. To illustrate, in some cases, an SVG property includes a visual attribute of an SVG object, such as an attributed indicating a position, shape, color, or opacity. Indeed, as FIG. 6 illustrates, the SVG properties 602 include an x position property 604, a y position property 606, a rotation property 608, a scale property 610, and an opacity property 612, though alternative and/or additional properties are determined in various embodiments.

In one or more embodiments, the image-to-data integration system 106 determines the SVG properties 602 by retrieving the SVG properties 602 from the SVG specification. In particular, in some cases, the image-to-data integration system 106 retrieves the SVG properties 602 from the SVG 2 specification in accordance with the recommendations of the Word Wide Web Consortium (W3C). In one or more embodiments, the image-to-data integration system 106 determines the SVG properties 602 by determining the SVG property names (e.g., the names given by the SVG specification 2). Thus, in some embodiments, the SVG properties 602 are associated with the SVG objects generated from a raster image as the SVG properties 602 include those properties that will be assumed by the SVG objects (e.g., in the final SVG image).

As further shown in FIG. 6, the image-to-data integration system 106 determines label components 614 for the raster objects depicted in the raster image as discussed above with reference to FIG. 5. Additionally, the image-to-data integration system 106 obtains the data file 616 (e.g., by receiving the data file 616 from a client device or third-party system or by accessing the data file 616 from local or remote storage).

As FIG. 6 illustrates, the image-to-data integration system 106 uses a sentence transformer neural network 618 to generate embeddings 620 for the SVG properties 602, the label components 614, and the data file 616. In one or more embodiments, a sentence transformer neural network includes a computer-implemented neural network that generates embeddings from text. In particular, in some embodiments, a sentence transformer neural network includes a computer-implemented neural network having a transformer architecture that is configured and trained to generate embeddings from text. In some instances, a sentence transformer neural network generates an embedding as a fixed-size vector representation of input text, regardless of the length of the input text.

To illustrate, in some cases, the image-to-data integration system 106 uses the transformer neural network 618 to generate an embedding for each of the SVG properties 602 (e.g., the name of each SVG property). In some embodiments, the image-to-data integration system 106 generates an embedding for each row name of the data file 616 and also generates an embedding for each column name of the data file 616. Indeed, as previously mentioned, in some cases, the data file 616 used by the image-to-data integration system 106 includes a plurality of data fields organized into rows and columns. Thus, in some embodiments, each column has a column name, and each row has a row name. In some instances, the row name is the entry (e.g., the value) in the first data field in that row and/or the column name is the entry (e.g., the value) in the first data field in that column. In some implementations, however, the data file 616 includes separate row names and/or column names that specify the type of data included in that row or column, respectively. In certain embodiments, the image-to-data integration system 106 further generates embeddings for metadata of the data file 616.

Additionally, in one or more embodiments, the image-to-data integration system 106 uses the transformer neural network 618 to generate an embedding for each label component from the label components 614. For example, in some embodiments, the image-to-data integration system 106 generates an embedding for each label and also generates an embedding for each textual description. In some cases, the image-to-data integration system 106 combines the label and textual description for each object from which they were generated and uses the transformer neural network 618 to generate an embedding for the combination.

As illustrated in FIG. 6, the image-to-data integration system 106 uses the embeddings 620 to determine data bindings 622. In particular, in some embodiments, the image-to-data integration system 106 uses the embeddings 620 to determine a mapping that maps data elements from various sources, such as the SVG properties 602, the label components 614, and the data file 616. In some cases, the image-to-data integration system 106 uses the embeddings 620 to associate pairs of data elements. For example, in some implementations, the image-to-data integration system 106 determines cosine pairwise similarities for the embeddings 620 and uses the determined similarities to determine pairs of data elements for the mapping.

In some cases, the image-to-data integration system 106 determines the data bindings 622 by pairing particular data element types together. For instance, in some cases, the image-to-data integration system 106 pairs labels from the label components 614 with row names from the data file 616. Thus, in some cases, the image-to-data integration system 106 determines pairwise cosine similarities for the embeddings generated from the labels and the row names and determines which labels map to which row names based on the pairwise cosine similarities. As another example, in some instances, the image-to-data integration system 106 pairs the SVG properties 602 (e.g., the property names) with column names from the data file 616. Accordingly, in some implementations, the image-to-data integration system 106 determines pairwise cosine similarities for the embeddings generated from the SVG properties 602 and the column names and determines which SVG properties map to which column names based on the pairwise cosine similarities.

In certain embodiments, the image-to-data integration system 106 determines the data bindings 622 by determining pairwise cosine similarities for all potential combinations of data elements regardless of type and mapping those data elements associated with the best (e.g., highest) pairwise cosine similarities. To illustrate, in some cases, the image-to-data integration system 106 determines pairwise cosine similarities for pairings that include an embedding for a label and embeddings for each row name, column name, textual description, and SVG property. The image-to-data integration system 106 determines to map the label to the data element that provides the label with the best pairwise cosine similarity. Thus, in some instances, the image-to-data integration system 106 potentially pairs data elements of one type with data elements of various other types.

In one or more embodiments, the image-to-data integration system 106 provides the data bindings 622 as a recommended mapping to a client device. Indeed, in some cases, the image-to-data integration system 106 prompts the client device to provide input before finalizing the data bindings 622. Upon receiving user input for accepting the recommended mapping, the image-to-data integration system 106 finalizes (e.g., maintains) the data bindings 622. Otherwise, the image-to-data integration system 106 modifies the data bindings 622 in accordance with user input received via the client device.

In some embodiments, by determining the data bindings 622, the image-to-data integration system 106 determines how data from the data file 616 is to be embedded or otherwise incorporated within the SVG image to be generated from the raster image. In particular, the image-to-data integration system 106 determines how the data from the data file 616 is to be bound to the SVG objects that will be included in the SVG image. For example, by binding a label generated for a raster image to a row name from the data file 616, the image-to-data integration system 106 determines that the values of the data fields in that row are to be associated with the SVG object generated from the raster image. Further, by binding an SVG property to a column name from the data file 616, the image-to-data integration system 106 determines that values of the data fields for that column are to be associated with that SVG property. Thus, using the data bindings 622, the image-to-data integration system 106 determines how the value of a particular data field from the data file 616 is to be incorporated within a particular SVG object generated from the raster image.

To illustrate, in some cases, the image-to-data integration system 106 binds a row name from the data file 616 to a label from the label components 614—that is, a label generated for a raster object depicted in the raster image. Thus, the image-to-data integration system 106 determines that the row of the data file 616 corresponds to the raster object. In other words, the image-to-data integration system 106 determines that the data fields of the row contain a record of data for the raster object. Additionally, the image-to-data integration system 106 binds a column name from the data file 616 to a SVG property from the SVG properties 602. Thus, the image-to-data integration system 106 determines that the column of the data file 616 corresponds to the SVG property. In other words, the image-to-data integration system 106 determines that the data fields of the column contain values to be used in incorporating the SVG property within the SVG objects of the resulting SVG image. Based on these bindings, the image-to-data integration system 106 determines that a particular data field of the data file 616—located at an intersection of the row and the column—includes a value to be used in incorporating the SVG property bound to the column within the SVG object generated from the raster object bound to the row. In other words, the data field is bound to the SVG property and raster object (e.g., the SVG object to be generated from the raster object).

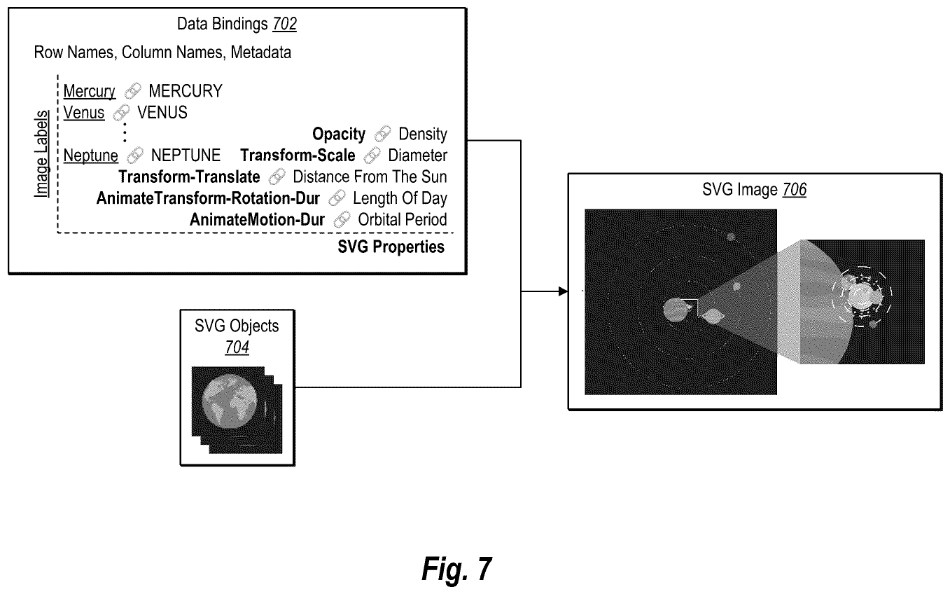

As previously mentioned, in one or more embodiments, the image-to-data integration system 106 generates an SVG image from a raster image. In particular, in some embodiments, the image-to-data integration system 106 generates an SVG image depicting SVG objects within the same scene depicted by the raster object. FIG. 7 illustrates the image-to-data integration system 106 generating an SVG image in accordance with one or more embodiments.

Indeed, as shown in FIG. 7, the image-to-data integration system 106 uses data bindings 702 and SVG objects 704 created from a raster image to generate an SVG image 706. Thus, the SVG image 706 depicts the SVG objects 704, and the SVG objects 704 incorporate the data bindings. For instance, in some cases, the image-to-data integration system 106 embeds data elements from the data file used in determining the data bindings 702 (e.g., values entered into the data fields of data file) into the SVG objects 704 in accordance with the data bindings 702.

As mentioned above, in some cases, the image-to-data integration system 106 uses the data bindings 702 to determine how data from the data file is to be incorporated within the SVG image. In particular, the image-to-data integration system 106 uses the data bindings 702 to determine how the data is to be incorporated within the SVG objects 704 of the SVG image 706.

To illustrate, in some embodiments, the data fields of the data file include values corresponding to static attributes of an object. Thus, the image-to-data integration system 106 uses the data bindings 702 to determine how to incorporate the static attributes within the SVG objects 704 of the SVG image 706.

In one or more embodiments, a static attribute includes an attribute of an object that is not associated with motion. In particular, in some embodiments, a static attribute includes an attribute of an object that is fixed. In other words, the attribute (e.g., the value of the attribute) does not change over time. Some examples of a static attribute include color, shape, density, or opacity.

In some cases, the image-to-data integration system 106 modifies data fields from the data file (e.g., modifies the values of the data fields) when incorporating them within their corresponding SVG object in accordance with the data bindings 702. Indeed, in some cases, the value of a data field within the data file is outside the range of values of the SVG property that is bound to that data field. Thus, in certain embodiments, the image-to-data integration system 106 modifies the value of a data field to be within that range.

Thus, in some cases, when incorporating a static attribute within an SVG object when generating an SVG image, the image-to-data integration system 106 scales the data field corresponding to the SVG object and the SVG property to the range of values supported by the SVG property. As one example, if mapping density from the data file to the SVG property opacity, the image-to-data integration system 106 scales the density value from the data file to fit within the range of values [0,1], which is supported by opacity (e.g., when the density value doesn't already fit within the range).

In some embodiments, upon ensuring the data values from the data file are within supported SVG property value ranges, the image-to-data integration system 106 generates one or more attribute strings for each SVG object, where each attribute string corresponds to a data field having a value to be incorporated within the SVG object. In some instances, the image-to-data integration system 106 further merges the attribute strings for the SVG object to create a final attribute string for the SVG object. In certain cases, the image-to-data integration system 106 accounts for overlaps where multiple data fields are mapped to the same SVG property by summing the values within the final attribute string. In some cases, the image-to-data integration system 106 configures the final attribute string so it is capable of being parsed by a web browser. In one or more embodiments, the image-to-data integration system 106 converts each SVG object to a <group> element and appends the element to a larger SVG wrapper to produce the final SVG output (i.e., the SVG image 706).

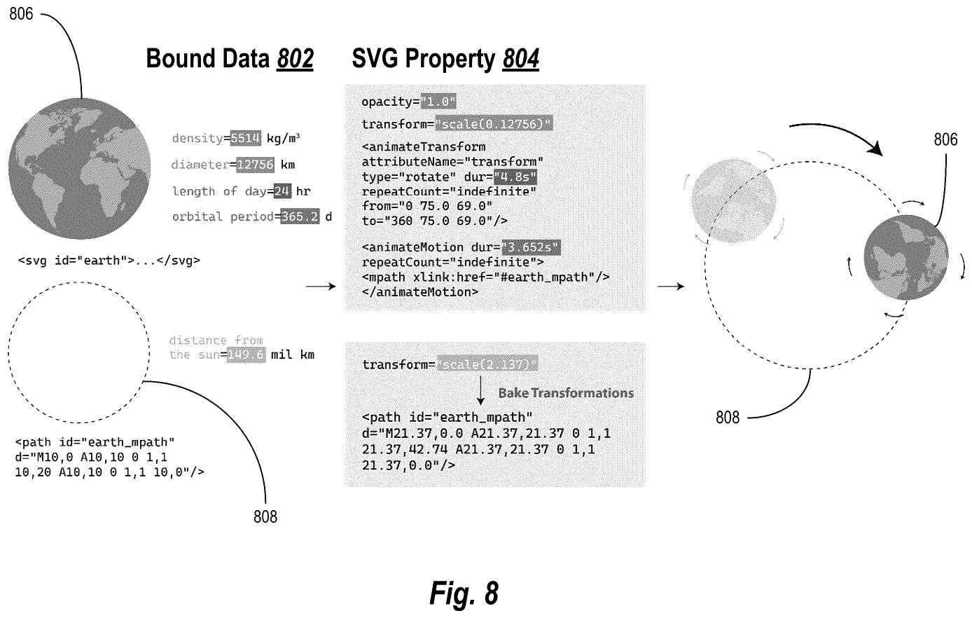

As mentioned, in some embodiments, the image-to-data integration system 106 incorporates static attributes within the SVG objects of an SVG image generated from a raster image. In other words, in some cases, the data file bound to the SVG image includes values that correspond to static attributes, which are bound to corresponding SVG properties. In some implementations, however, the image-to-data integration system 106 incorporates one or more animation attributes within one or more of the SVG objects of the SVG image. Indeed, in some cases, the data file bound to the SVG image includes values that correspond to animation attributes, which are bound to corresponding SVG properties. FIG. 8 illustrates the image-to-data integration system 106 incorporating animation attributes within an SVG image in accordance with one or more embodiments.

In one or more embodiments, an animation attribute includes an attribute of an object that is not associated with motion. In particular, in some embodiments, an animation attribute includes an attribute of an object that is not fixed. In other words, the attribute (e.g., the value of the attribute) changes over time. Some examples of an animation attribute include rotation and position.

In some cases, the image-to-data integration system 106 incorporates animation attributes that indicate in-situ animation or motion-path animation. In one or more embodiments, in-situ animation includes animation that changes an object in place. For instance, in some cases an in-situ animation includes a rotation of an object in place. Further, in one or more embodiments, a motion-path animation includes animation that changes the position of an object in space. For example, in some cases, a motion-path animation moves an object over a path.

In one or more embodiments, the image-to-data integration system 106 incorporates an in-situ animation attribute within an SVG object in the same way in which a static attribute is incorporated as described above. In some instances, however, rather than modifying the data field, the image-to-data integration system 106 adds <animate> and/or <animateTransform> child elements to the SVG object and maps the values to these elements. In some cases, the image-to-data integration system 106 still modifies the data field before mapping to the <animate> or <animateTransform> child element.

In one or more embodiments, the image-to-data integration system 106 incorporates a motion-path animation attribute within an SVG object by extracting the path from the raster image or determining the path based on received user input. The image-to-data integration system 106 also instructs an SVG object to follow the path by adding an <animateMotion> and/or <mpath> tag. In instances, because the SVG specification provides that path following only works for the absolute coordinates of a path (specified by the d attribute), the image-to-data integration system 106 includes a custom function that incorporates transformation matrices into path commands. The image-to-data integration system 106 configures the function to be called each time the SVG object is moved, scaled, or rotated.

Indeed, as shown in FIG. 8, the image-to-data integration system 106 incorporates data 802 within an SVG object 806 by adding the data to the SVG properties 804 of the SVG object 806. Some of the data (e.g., “density”) indicates a static attribute and is incorporated as described above (e.g., by scaling the value of “density” to fit within the range of values supported by the “opacity” SVG property that is bound to “density”). Some of the data (e.g., “length of day”) indicates an in-situ animation attribute and is incorporated to provide the SVG object 806 with in-situ animation (e.g., by adding an animation of type “rotate” with a given value to the SVG object 806). Further, some of the data (e.g., “orbital period”) indicates a motion-path animation attribute and is incorporated to provide the SVG object 806 with motion-path animation (e.g., by determining path 808 and adding a path command with the <animateMotion> tag for the path). Further, the image-to-data integration system 106 incorporates the “transform” function to enable the incorporate transformation matrices into the path command. Thus, the image-to-data integration system 106 generates the SVG object 806 to incorporate various static and animation attributes.

By generating SVG images as described above, the image-to-data integration system 106 provides improved flexibility when compared to conventional systems. In particular, the image-to-data integration system 106 flexibly implements a pipeline unavailable under many conventional systems for generating a data-bound vector output from a raster input. Further, by generating the vector output as described above, the image-to-data integration system 106 flexibly maintains the scene depicted by the raster input. Indeed, while many conventional systems use an input image as a background, glyph, or stylistic guide for creating a new image with a new pictorial visualization, the image-to-data integration system 106 generates an SVG image depicting the same scene as the input raster image. As such, the image-to-data integration system 106 binds existing images—particularly those providing a pictorial visualization—to data from an external data source to enable those images to more accurately convey their insights.

Turning now to FIG. 9, additional detail will now be provided regarding various components and capabilities of the image-to-data integration system 106. In particular, FIG. 9 illustrates the image-to-data integration system 106 implemented by the computing device 900 (e.g., the server device(s) 102 and/or one of the client devices 110a-110n discussed above with reference to FIG. 1). Additionally, the image-to-data integration system 106 is part of the image editing system 104. As shown in FIG. 9, the image-to-data integration system 106 includes, but is not limited to, a raster deconstruction engine 902, an object labeling engine 904, a data binding manager 906, and data storage 908 (which includes machine learning models 910, SVG properties 912, and a data file 914).

As just mentioned, and as illustrated in FIG. 9, the image-to-data integration system 106 includes the raster deconstruction engine 902. In one or more embodiments, the raster deconstruction engine 902 deconstructs an input raster image. For instance, in some embodiments, the raster deconstruction engine 902 detects raster objects within the raster image, generates a cropped image with the background removed for each detected raster object, and generates quantized bitmaps from the cropped images. In some cases, the raster deconstruction engine 902 further generates an SVG object for each detected raster object using the corresponding quantized bitmaps. Indeed, in some cases, the raster deconstruction engine 902 generates Bezier curves from the quantized bitmaps, generates SVG path commands using the Bezier curves, and generates the SVG object using the SVG path commands.

Additionally, as shown in FIG. 9, the image-to-data integration system 106 includes the object labeling engine 904. In one or more embodiments, the object labeling engine 904 generates label components for a raster input image. In particular, in some embodiments, the object labeling engine 904 generates a label and a textual description for each raster object depicted in the raster image. In some cases, the object labeling engine 904 generates the label components using a language machine learning model.

As further shown in FIG. 9, the image-to-data integration system 106 includes the data binding manager 906. In one or more embodiments, the data binding manager 906 binds data from a data file to an input raster image. In particular, in some embodiments, the data binding manager 906 binds data to SVG objects created from an input raster image. For instance, in some cases, the data binding manager 906 uses a sentence transformer neural network to generate embeddings for data elements from various data sources (e.g., row names from a data file, column names from a data file, labels for the raster objects, textual descriptions for the raster objects, and/or SVG property names). The data binding manager 906 further uses pairwise cosine similarities to determine how to map the data elements to one another. In some cases, the data binding manager 906 provides the data bindings as a recommended mapping and adjust the data bindings upon receiving user input with respect to the recommendation.

Further, as shown in FIG. 9, the image-to-data integration system 106 includes data storage 908. In particular, data storage 908 includes machine learning models 910, SVG properties 912, and the data file 914. In some cases, machine learning models 910 include the machine learning models to deconstruct the input raster image, generate label components from the raster image, and/or determine the data bindings. In some embodiments, SVG properties 912 includes those SVG properties that are bound to data. Additionally, in some instances, the data file 914 includes the data file having data bound to the SVG properties.

Each of the components 902-914 of the image-to-data integration system 106 optionally include software, hardware, or both. For example, in some cases, the components 902-914 include one or more instructions stored on a computer-readable storage medium and executable by processors of one or more computing devices, such as a client device or server device. When executed by the one or more processors, the computer-executable instructions of one or more embodiments of the image-to-data integration system 106 cause the computing device(s) to perform the methods described herein. Alternatively, in some instances, the components 902-914 include hardware, such as a special-purpose processing device to perform a certain function or group of functions. Alternatively, in certain implementations, the components 902-914 of the image-to-data integration system 106 include a combination of computer-executable instructions and hardware.

Furthermore, in one or more embodiments, the components 902-914 of the image-to-data integration system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 902-914 of the image-to-data integration system 106 are implemented as a stand-alone application, such as a desktop or mobile application. Furthermore, in some cases, the components 902-914 of the image-to-data integration system 106 are implemented as one or more web-based applications hosted on a remote server. Alternatively, or additionally, the components 902-914 of the image-to-data integration system 106 are implemented in a suite of mobile device applications or “apps.” For example, in one or more embodiments, the image-to-data integration system 106 comprises or operates in connection with digital software applications such as ADOBE® ACROBAT® or ADOBE® ILLUSTRATOR®. The foregoing are either registered trademarks or trademarks of Adobe Inc. in the United States and/or other countries.

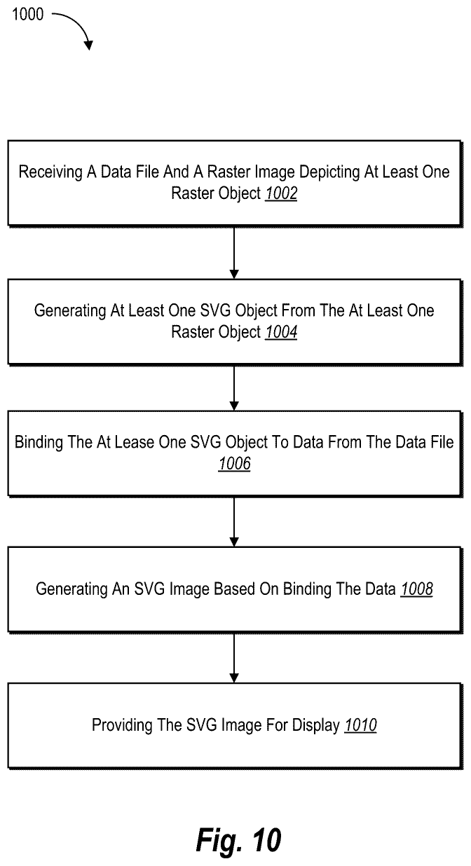

FIGS. 1-9, the corresponding text, and the examples provide a number of different methods, systems, devices, and non-transitory computer-readable media of the image-to-data integration system 106. In addition to the foregoing, one or more embodiments are also described in terms of flowcharts comprising acts for accomplishing the particular result, as shown in FIG. 10. In one or more embodiments, FIG. 10 is performed with more or fewer acts. Further, in some embodiments, the acts are performed in different orders. Additionally, in some cases, the acts described herein are repeated or performed in parallel with one another or in parallel with different instances of the same or similar acts.

FIG. 10 illustrates a flowchart of a series of acts 1000 for generating a data-bound SVG image from an input raster image in accordance with one or more embodiments. FIG. 10 illustrates acts according to one embodiment, but alternative embodiments omit, add to, reorder, and/or modify any of the acts shown in FIG. 10. In some implementations, the acts of FIG. 10 are performed as part of a method. Alternatively, in some embodiments, a non-transitory computer-readable medium stores executable instructions thereon that, when executed by a processing device, cause the processing device to perform operations comprising the acts of FIG. 10. In some embodiments, a system performs the acts of FIG. 10. For example, in some cases, a system includes one or more memory components. The system further includes one or more processing devices coupled to the one or more memory components, the one or more processing devices to perform operations comprising the acts of FIG. 10.

The series of acts 1000 includes an act 1002 for receiving a data file and a raster image depicting at least one raster object. For example, in one or more embodiments, the act 1002 involves receiving, from a client device, a data file and a raster image depicting at least one raster object within a scene.

The series of acts 1000 also includes an act 1004 for generating at least one SVG object from the at least one raster object. For instance, in some embodiments, the act 1004 involves generating, from the at least one raster object of the raster image, at least one scalar vector graphic object.

In some implementations, the image-to-data integration system 106 further generates, from the raster image, a cropped image for a raster object from the at least one raster object. Thus, in some cases, generating the at least one scalar vector graphic object from the at least one raster object comprises generating a scalar vector graphic object using the cropped image of the raster object. Additionally, in some instances, the image-to-data integration system 106 further generates, from the raster image, a plurality of quantized bitmaps for the raster object using the cropped image for the raster object. As such, in certain embodiments, generating the scalar vector graphic object using the cropped image of the raster object comprises generating the scalar vector graphic object using the plurality of quantized bitmaps for the raster object. In one or more embodiments, generating the scalar vector graphic object using the plurality of quantized bitmaps for the raster object comprises: generating, from a quantized bitmap and using a polygon-based tracing model, one or more Bezier curves for the raster object; determining, from the one or more Bezier curves, one or more scalar vector graphic path commands; and generating the scalar vector graphic object from the one or more scalar vector graphic path commands.

Additionally, the series of acts 1000 includes an act 1006 for binding the at least one SVG object to data from the data file. Indeed, in some cases, the act 1006 involves determining a mapping between the at least one SVG object and data from the data file.

In one or more embodiments, binding the at least one scalar vector graphic object to the data from the data file comprises: determining one or more scalar vector graphic properties for the at least one scalar vector graphic object; generating a first set of embeddings for the one or more scalar vector graphic properties; generating a second set of embeddings for the data from the data file; and binding the at least one scalar vector graphic object to the data from the data file using the first set of embeddings and the second set of embeddings. Additionally, in some embodiments, binding the at least one scalar vector graphic object to the data from the data file using the first set of embeddings and the second set of embeddings comprises binding the at least one scalar vector graphic object to the data using pairwise cosine similarities between embeddings from the first set of embeddings and additional embeddings from the second set of embeddings.

In some implementations, binding the at least one scalar vector graphic object to the data from the data file comprises binding the at least one scalar vector graphic object to the data in accordance with user input received from the client device.

The series of acts 1000 further includes an act 1008 for generating an SVG image based on binding the data. To illustrate, in certain embodiments, the act 1008 involves generating a scalar vector graphic image depicting the at least one scalar vector graphic object within the scene based on the data bound to the at least one scalar vector graphic object.

In one or more embodiments, generating the scalar vector graphic image depicting the at least one scalar vector graphic object based on the data bound to the at least one scalar vector graphic object comprises generating an animated scalar vector graphic image depicting an animation of the at least one scalar vector graphic object within the scene based on one or more animation attributes included in the data bound to the at least one scalar vector graphic object. In some embodiments, generating the animated scalar vector graphic image depicting the animation of the at least one scalar vector graphic object comprises generating the animated scalar vector graphic image depicting a motion-path animation of the at least one scalar vector graphic object.

The series of acts 1000 also includes an act 1010 for providing the SVG image for display. For example, in some cases, the act 1010 involves providing the scalar vector graphic image for display on a graphical user interface (e.g., the graphical user interface of the client device that provided the raster image and data file or the graphical user interface of another client device accessing the SVG image).

To provide an illustration, in one or more embodiments, the image-to-data integration system 106 determines, using an object detection model, a raster object depicted within a scene of a raster image; generates, from the raster object of the raster image, a scalar vector graphic object; binding the scalar vector graphic object to data from a data file, the data comprising one or more animation attributes; and generating an animated scalar vector graphic image depicting an animation of the scalar vector graphic object within the scene based on the one or more animation attributes bound to the scalar vector graphic object.

In some embodiments, binding the scalar vector graphic object to the data comprising the one or more animation attributes comprises binding the scalar vector graphic object to the data comprising one or more in-situ animation attributes. In some cases, the image-to-data integration system 106 further generates a cropped image of the raster object using the raster image; and removes a background of the cropped image. Accordingly, in some cases, generating the scalar vector graphic object from the raster object comprises generating the scalar vector graphic object from the cropped image of the raster object with the background removed.

In some implementations, the image-to-data integration system 106 further generates, using a language machine learning model, a label and a textual description for the raster object depicted in the raster image. As such, in some instances, binding the scalar vector graphic object to the data from the data file comprises binding the scalar vector graphic object to the data using the label and the textual description for the raster object. Additionally, in certain embodiments, binding the scalar vector graphic object to the data using the label and textual description for the raster object comprises: generating, using a sentence transformer neural network, a first set of embeddings for the label and the textual description generated for the raster object; generating, using, the sentence transformer neural network, a second set of embeddings for the data from the data file; and binding the scalar vector graphic object to the data using the first set of embeddings and the second set of embeddings. In some embodiments, binding the scalar vector graphic object to the data using the first set of embeddings and the second set of embeddings comprises mapping the scalar vector graphic object to the data using pairwise cosine similarities determined for embeddings from the first set of embeddings and the second set of embeddings.

Further, in some cases, generating the animated scalar vector graphic image comprises generating an animated scalar vector graphic pictorial poster.

To provide another illustrate, in one or more embodiments, the image-to-data integration system 106 receives a data file and a raster image depicting at least one raster object within a scene; generates, from the at least one raster object of the raster image, at least one scalar vector graphic object; binds the at least one scalar vector graphic object to data from the data file; generates a scalar vector graphic image depicting the at least one scalar vector graphic object within the scene based on the data bound to the at least one scalar vector graphic object; and provides the scalar vector graphic image for display on a graphical user interface of a client device.

In some embodiments, binding the at least one scalar vector graphic object to the data from the data file comprises: generating, from a data field of the data, a scaled data field having a value within a range supported by a corresponding scalar vector graphic property; and binding the at least one scalar vector graphic object to the scaled data field. Further, in some cases, binding the at least one scalar vector graphic object to the data from the data file comprises binding the at least one scalar vector graphic object to the data using a plurality of embeddings representing row names for the data, column names for the data, a label for the at least one raster object, a textual description of the at least one raster object, and one or more scalar vector graphic property names for the at least one scalar vector graphic object.

In certain embodiments, the image-to-data integration system 106 further provides, to a client device, a recommended mapping between the at least one scalar vector graphic object and the data from the data file. As such, in some cases, binding the at least one scalar vector graphic object to the data from the data file comprises binding the at least one scalar vector graphic object to the data based on user input received via the client device with respect to the recommended mapping.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that is configured to perform one or more of the processes described above in some embodiments. One will appreciate that one or more computing devices, such as the computing device 1100, represent the computing devices described above (e.g., the server device(s) 102 and/or the client devices 110a-110n) in some implementations. In one or more embodiments, the computing device 1100 is a mobile device (e.g., a mobile telephone, a smartphone, a PDA, a tablet, a laptop, a camera, a tracker, a watch, a wearable device). In some embodiments, the computing device 1100 is a non-mobile device (e.g., a desktop computer or another type of client device). Further, in certain embodiments, the computing device 1100 is a server device that includes cloud-based processing and storage capabilities.

As shown in FIG. 11, the computing device 1100 includes one or more processor(s) 1102, memory 1104, a storage device 1106, input/output interfaces 1108 (or “I/O interfaces 1108”), and a communication interface 1110, which are communicatively coupled by way of a communication infrastructure (e.g., bus 1112). While the computing device 1100 is shown in FIG. 11, the components illustrated in FIG. 11 are not intended to be limiting. Additional or alternative components are used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 retrieve (or fetch) the instructions from an internal register, an internal cache, memory 1104, or a storage device 1106 and decode and execute them in some implementations.

The computing device 1100 includes memory 1104, which is coupled to the processor(s) 1102. In certain cases, the memory 1104 is used for storing data, metadata, and programs for execution by the processor(s). In some instances, the memory 1104 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 1104 includes internal or distributed memory.

The computing device 1100 includes a storage device 1106 including storage for storing data or instructions. As an example, and not by way of limitation, in some cases, the storage device 1106 includes a non-transitory storage medium described above. In some embodiments, the storage device 1106 includes a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. In one or more embodiments, these I/O interfaces 1108 include a mouse, keypad or a keyboard, a touch screen, camera, optical scanner, network interface, modem, other known I/O devices or a combination of such I/O interfaces 1108. In some cases, the touch screen is activated with a stylus or a finger.

In one or more embodiments, the I/O interfaces 1108 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. In some cases, the graphical data is representative of one or more graphical user interfaces and/or any other graphical content that serves a particular implementation.

The computing device 1100 further includes a communication interface 1110. In some cases, the communication interface 1110 includes hardware, software, or both. The communication interface 1110 provides one or more interfaces for communication (such as, for example, packet-based communication) between the computing device and one or more other computing devices or one or more networks. As an example, and not by way of limitation, in some cases, communication interface 1110 includes a network interface controller (NIC) or network adapter for communicating with an Ethernet or other wire-based network or a wireless NIC (WNIC) or wireless adapter for communicating with a wireless network, such as a WI-FI. The computing device 1100 further includes a bus 1112. In some cases, the bus 1112 includes hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, a data file and a raster image depicting at least one raster object within a scene;
generating, from the at least one raster object of the raster image, at least one scalar vector graphic object;
binding the at least one scalar vector graphic object to data from the data file;
generating a scalar vector graphic image depicting the at least one scalar vector graphic object within the scene based on the data bound to the at least one scalar vector graphic object; and
providing the scalar vector graphic image for display on a graphical user interface.

2. The method of claim 1, wherein generating the scalar vector graphic image depicting the at least one scalar vector graphic object based on the data bound to the at least one scalar vector graphic object comprises generating an animated scalar vector graphic image depicting an animation of the at least one scalar vector graphic object within the scene based on one or more animation attributes included in the data bound to the at least one scalar vector graphic object.

3. The method of claim 2, wherein generating the animated scalar vector graphic image depicting the animation of the at least one scalar vector graphic object comprises generating the animated scalar vector graphic image depicting a motion-path animation of the at least one scalar vector graphic object.

4. The method of claim 1,
further comprising generating, from the raster image, a cropped image for a raster object from the at least one raster object,
wherein generating the at least one scalar vector graphic object from the at least one raster object comprises generating a scalar vector graphic object using the cropped image of the raster object.

5. The method of claim 4,
further comprising generating, from the raster image, a plurality of quantized bitmaps for the raster object using the cropped image for the raster object,
wherein generating the scalar vector graphic object using the cropped image of the raster object comprises generating the scalar vector graphic object using the plurality of quantized bitmaps for the raster object.

6. The method of claim 5, wherein generating the scalar vector graphic object using the plurality of quantized bitmaps for the raster object comprises:
generating, from a quantized bitmap and using a polygon-based tracing model, one or more Bezier curves for the raster object;
determining, from the one or more Bezier curves, one or more scalar vector graphic path commands; and
generating the scalar vector graphic object from the one or more scalar vector graphic path commands.

7. The method of claim 1, wherein binding the at least one scalar vector graphic object to the data from the data file comprises:
determining one or more scalar vector graphic properties for the at least one scalar vector graphic object;
generating a first set of embeddings for the one or more scalar vector graphic properties;
generating a second set of embeddings for the data from the data file; and
binding the at least one scalar vector graphic object to the data from the data file using the first set of embeddings and the second set of embeddings.

8. The method of claim 7, wherein binding the at least one scalar vector graphic object to the data from the data file using the first set of embeddings and the second set of embeddings comprises binding the at least one scalar vector graphic object to the data using pairwise cosine similarities between embeddings from the first set of embeddings and additional embeddings from the second set of embeddings.

9. The method of claim 1, wherein binding the at least one scalar vector graphic object to the data from the data file comprises binding the at least one scalar vector graphic object to the data in accordance with user input received from the client device.

10. A system comprising:
one or more memory components; and
one or more processing devices coupled to the one or more memory components, the one or more processing devices to perform operations comprising:
determining, using an object detection model, a raster object depicted within a scene of a raster image;
generating, from the raster object of the raster image, a scalar vector graphic object;
binding the scalar vector graphic object to data from a data file, the data comprising one or more animation attributes; and
generating an animated scalar vector graphic image depicting an animation of the scalar vector graphic object within the scene based on the one or more animation attributes bound to the scalar vector graphic object.

11. The system of claim 10, wherein binding the scalar vector graphic object to the data comprising the one or more animation attributes comprises binding the scalar vector graphic object to the data comprising one or more in-situ animation attributes.

12. The system of claim 10, wherein:
the operations further comprise:
generating a cropped image of the raster object using the raster image; and
removing a background of the cropped image; and
generating the scalar vector graphic object from the raster object comprises generating the scalar vector graphic object from the cropped image of the raster object with the background removed.

13. The system of claim 10, wherein:
the operations further comprise generating, using a language machine learning model, a label and a textual description for the raster object depicted in the raster image; and
binding the scalar vector graphic object to the data from the data file comprises binding the scalar vector graphic object to the data using the label and the textual description for the raster object.

14. The system of claim 13, wherein binding the scalar vector graphic object to the data using the label and textual description for the raster object comprises:
generating, using a sentence transformer neural network, a first set of embeddings for the label and the textual description generated for the raster object;
generating, using, the sentence transformer neural network, a second set of embeddings for the data from the data file; and
binding the scalar vector graphic object to the data using the first set of embeddings and the second set of embeddings.

15. The system of claim 14, wherein binding the scalar vector graphic object to the data using the first set of embeddings and the second set of embeddings comprises mapping the scalar vector graphic object to the data using pairwise cosine similarities determined for embeddings from the first set of embeddings and the second set of embeddings.

16. The system of claim 10, wherein generating the animated scalar vector graphic image comprises generating an animated scalar vector graphic pictorial poster.

17. A non-transitory computer-readable medium storing executable instructions, which when executed by a processing device, cause the processing device to perform operations comprising:
receiving a data file and a raster image depicting at least one raster object within a scene;
generating, from the at least one raster object of the raster image, at least one scalar vector graphic object;
binding the at least one scalar vector graphic object to data from the data file;
generating a scalar vector graphic image depicting the at least one scalar vector graphic object within the scene based on the data bound to the at least one scalar vector graphic object; and
providing the scalar vector graphic image for display on a graphical user interface of a client device.

18. The non-transitory computer-readable medium of claim 17, wherein binding the at least one scalar vector graphic object to the data from the data file comprises:
generating, from a data field of the data, a scaled data field having a value within a range supported by a corresponding scalar vector graphic property; and
binding the at least one scalar vector graphic object to the scaled data field.

19. The non-transitory computer-readable medium of claim 17, wherein:
the operations further comprise providing, to a client device, a recommended mapping between the at least one scalar vector graphic object and the data from the data file; and
binding the at least one scalar vector graphic object to the data from the data file comprises binding the at least one scalar vector graphic object to the data based on user input received via the client device with respect to the recommended mapping.

20. The non-transitory computer-readable medium of claim 17, wherein binding the at least one scalar vector graphic object to the data from the data file comprises binding the at least one scalar vector graphic object to the data using a plurality of embeddings representing row names for the data, column names for the data, a label for the at least one raster object, a textual description of the at least one raster object, and one or more scalar vector graphic property names for the at least one scalar vector graphic object.
